(19) United States
(12) Patent Application Publication
(10) Pub. No.: US 2010/0169108 A1
(43) Pub. Date: Jul. 1, 2010

(54) DISTRIBUTED NETWORKS USED FOR HEALTH-BASED DATA COLLECTION

(75) Inventors: Chris Demetrios Karkanias, Sammamish, WA (US); Neil A. Jordan, Seattle, WA (US)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 12/346,968

(22) Filed: Dec. 31, 2008

(51) Int. Cl. G06Q 50/00; G06Q 90/00

(52) U.S. Cl. 705/2

(57) ABSTRACT

The claimed subject matter provides a system and/or a method that facilitates aggregating data with a distributed network for health-related diagnosis. A device can include a sensor for dynamic collection of data, wherein the portion of data is wirelessly communicated from the device to a distributed network. An evaluator can generate a health informative update based at least in part upon an analysis of the dynamically collected data received via the distributed network, wherein the evaluator analyzes a medical condition with a condition-indicative level of the portion of data collected via the sensor. The health informative update can be at least one of a personal update providing information pertaining to an individual-based medical condition or a geographic-based population update providing information related to a medical condition that affects a pre-defined number of individuals within the geographic-based population.

### BACKGROUND

Technological advances in computer hardware, software and networking have lead to increased demand for electronic information exchange rather than through conventional techniques such as paper correspondence, for example. Such electronic communication can provide split-second, reliable data transfer between essentially any two locations throughout the world. Many industries and consumers are leveraging such technology to improve efficiency and decrease cost through web-based (e.g., on-line) services. For example, consumers can purchase goods, review bank statements, research products and companies, obtain real-time stock quotes, download brochures, etc. with the click of a mouse and at the convenience of home.

In light of such technological advances, people in general tend to be more and more concerned about incorporating such technology into their everyday lives. For example, cell phones, handhelds, wireless Internet, portable digital assistants (PDAs), and the like have enabled people to increase productivity and decrease downtime. Furthermore, these devices can provide a continuous access to information which can enable people to be more educated in making decisions about complex matters—such complex matters that typical would require large quantities of time to evaluate or even a particular expertise gained from years of practice. For instance, purchasing stocks or commodities online is now frequently performed by large numbers of people referred to as “day traders,” wherein such purchases are normally made by each individual's research (e.g., real-time stock monitoring, websites, published materials, trends, market analysis, etc.) rather than leveraging a stock broker or similar professional.

In particular, society has increasingly pushed toward being more conscious of his or her health and fitness. Many vastly differing concerns exist, such as setting and obtaining personal fitness goals, long-term health goals, condition management, health monitoring, work-out tracking, etc. Merging personal health management into technology has slowly emerged in the forms of devices, applications, software, or interactive websites. Such personal health usually involves an active or conscious effort on the user's part. For example, an application on a user's cellular device that monitors distance or time for a workout must be activated or initiated. Based upon such user-initiation requirements, such personal health management applications, devices, software, websites, etc. do not provide a complete insight or understanding of a user's health condition or status.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The subject innovation relates to systems and/or methods that facilitate leveraging a distributed network in order to collect data utilized to provide health information updates. The potential for using distributed network or platforms such as cellular phone-based network has not yet been adequately realized. For example, mobile device users often carry such devices on a continuous basis which can enable the collection of health data on an ongoing basis. Such collected data can be propagated to a data store for aggregation/analysis and can further be used to notify or alert a user about personal or environmental factors (e.g., blood readings, oxygen level in blood, second-hand smoke intake, radiation exposure, etc.).

A device associated with a distributed network can collect data in real time in which an evaluator can aggregate such data to generate an informative heath update. The evaluator can analyze the collected data in order to identify potential medical conditions or concerns. The informative health update can be a population update or a personal update. For instance, the population update can indicate potential readings or levels gathered may be indicative of a medical condition that can affect a population. In another example, the personal update can be more tailored to an individual's personal health, wherein the update can inform of a potential medical condition or concern that specifically affects such user.

In accordance with another aspect of the subject innovation, an inquiry component can actively solicit information from a user in order to collect condition-specific information. In other words, a user can receive a personal informative health update related to a potential medical condition and the inquiry component can actively extract or solicit information from the user for such condition. Moreover, a geographic-based data collector optimizer can allow data collection to be distributed across two or more devices related to the distributed network and enable such collected to be shared for evaluation and/or generation of an informative health update. In other aspects of the claimed subject matter, methods are provided that facilitate aggregating health data via a distributed network for informative health updates.

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 illustrates a block diagram of an exemplary system that facilitates leveraging a distributed network in order to collect data utilized to provide health information updates.

FIG. 2 illustrates a block diagram of an exemplary system that facilitates aggregating health data via a distributed network for informative health updates.

FIG. 3 illustrates a block diagram of an exemplary system that facilitates managing devices associated with a distributed network in order to optimize health data collection.

FIG. 4 illustrates a block diagram of an exemplary system that facilitates enabling seamless health data collection utilizing a cloud.

FIG. 5 illustrates a block diagram of exemplary system that facilitates utilizing component sensors to collect information in accordance with the subject innovation.

FIG. 6 illustrates a block diagram of an exemplary system that facilitates collecting data via a device associated with a distributed network.

FIG. 7 illustrates an exemplary methodology for leveraging a distributed network in order to collect data utilized to provide health information updates.

FIG. 8 illustrates an exemplary methodology that facilitates aggregating health data via a distributed network for informative health updates.

FIG. 9 illustrates an exemplary networking environment, wherein the novel aspects of the claimed subject matter can be employed.

FIG. 10 illustrates an exemplary operating environment that can be employed in accordance with the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “data store,” “evaluator,” “sensor,” “device,” “cloud,” “network,” “optimizer,” and the like are intended to refer to a computer-related entity, either hardware, software (e.g., in execution), and/or firmware. For example, a component can be a process running on a processor, a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

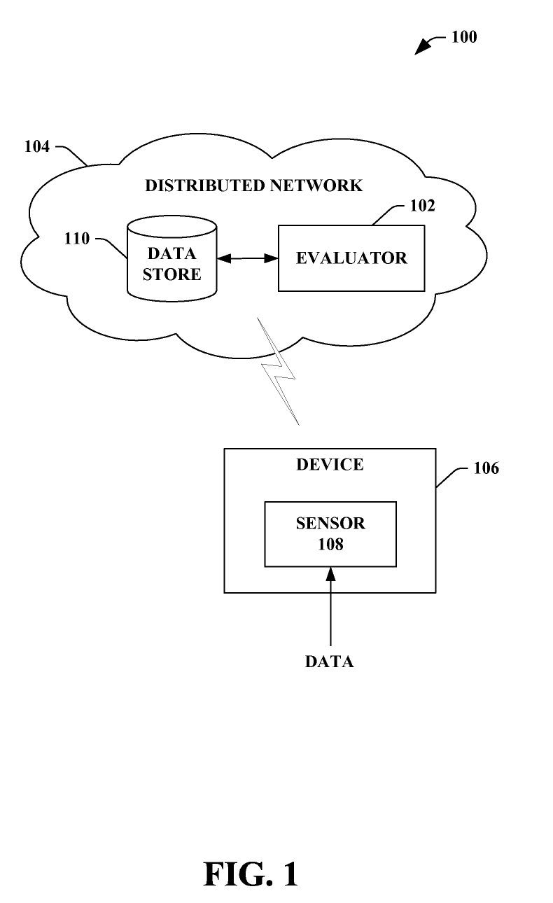

Now turning to the figures, FIG. 1 illustrates a system 100 that facilitate leveraging a distributed network in order to collect data utilized to provide health information updates. The system 100 can include the evaluator 102 that can identify a health informative update related to medical conditions based upon real-time data gathered from a device 106 and a sensor 108 via a distributed network 104. Generally, the system 100 can leverage the distributed network 104 (e.g., opportunistic network, structure network, peer-to-peer network, etc.) in order to facilitate dynamic and seamless data collection from the device 106, wherein such data collected can be analyzed by the evaluator 102 in order to generate a health informative update. The health informative update can be a personal update that provides information pertaining to an individual-based medical condition. Moreover, the health informative update can be a geographic-based population update, wherein a medical condition that affects a pre-defined number of individuals within the geographic-based population is identified. For instance, the system 100 can collect information from a plurality of users from respective devices and sensors in order to identify a medical-condition trend. In other words, the evaluator 102 can analyze data collected by the device 106 in order to provide a health informative update based upon such analysis and/or data collected.

For example, a user can have an individual-based medical condition such as a skin condition that can be aggravated with exposure to the sun for a period of time. In such example, a device and sensor can gather information related to sun exposure in order to provide a personal update informing of harmful exposure levels of the sun. In another example, a population within a particular geographic location can be informed of a breakout of food poisoning or other epidemic (e.g., flu outbreak, disease outbreak, virus, pandemic, etc.) based upon evaluation of data collected via devices and/or sensors from a plurality of users (representative of the geographic-based population).

It is to be appreciated that the device 106 and/or the sensor 108 can collect levels, readings, measurements, amounts, etc. of any suitable data associated with a medical condition. As discussed, such medical condition can be user-specific or generalized for a particular population. It is to be appreciated that the generalized medical condition can be organized or targeted for any suitable population organized on any suitable characteristic such as, but not limited to, geographic-location based, family member based, relationship based (e.g., friend, colleague, etc.), age based, gender based, blood type based, user-defined network, any other suitable characteristic that can be utilized to categorize two or more users, etc.

The system 100 can further include a data store 110 that can include any suitable data utilized or interacted with by the evaluator 102, the distributed network 104, the device 106, the sensor 108, etc. For example, the data store 110 can include, but not limited to including, health informative updates (e.g., personal update, population update, geographic-based population update, etc.), medical conditions, threshold levels for sensed parameters (e.g., acceptable levels, dangerous amounts, etc.), internal user health data, external user health data, correlations between sensed parameters and medical conditions, sensor settings, device and/or distributed network data, inquiry information (discussed in more detail below), data collection management information (discussed in more detail below), health data (e.g., low resolution data, lightweight data, etc.), user data, user profile data, user settings, user configurations, user preferences, verification techniques (e.g., human interactive proofs, security data, security question data, etc.), third-party healthcare information, dynamic health data collected, inference data, demographic data, device data (e.g., device settings, health data collection configurations), etc.

It is to be appreciated that the data store 110 can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM). The data store 110 of the subject systems and methods is intended to comprise, without being limited to, these and any other suitable types of memory. In addition, it is to be appreciated that the data store 110 can be a server, a database, a hard drive, a pen drive, an external hard drive, a portable hard drive, and the like.

The data store 110 can further be a semantic data store in which the meaning of the collected health data can be stored as facts about objects. In general, the data store 110 can include the following characteristics: semantic binary model, object-oriented features, semantically-enhanced object-relational, a collection of facts, arbitrary relationships, storing the inherent meaning of information, information in a natural form, information handling system, relationships between classes, no data size restriction, no data type restriction, ad hoc query, viewable relations, and/or no keys needed. It is to be further appreciated that any suitable number of data stores 110 can be implemented with the subject innovation, wherein the data stores can be a semantic data store, a relational data store, and/or any suitable combination thereof.

In addition, the system 100 can include any suitable and/or necessary interface component (not shown), which provides various adapters, connectors, channels, communication paths, etc. to integrate the evaluator 102 into virtually any operating and/or database system(s) and/or with one another. In addition, the interface component can provide various adapters, connectors, channels, communication paths, etc., that provide for interaction with the evaluator 102, the distributed network 104, the device 106, the sensor 108, the data store 110, and any other device and/or component associated with the system 100.

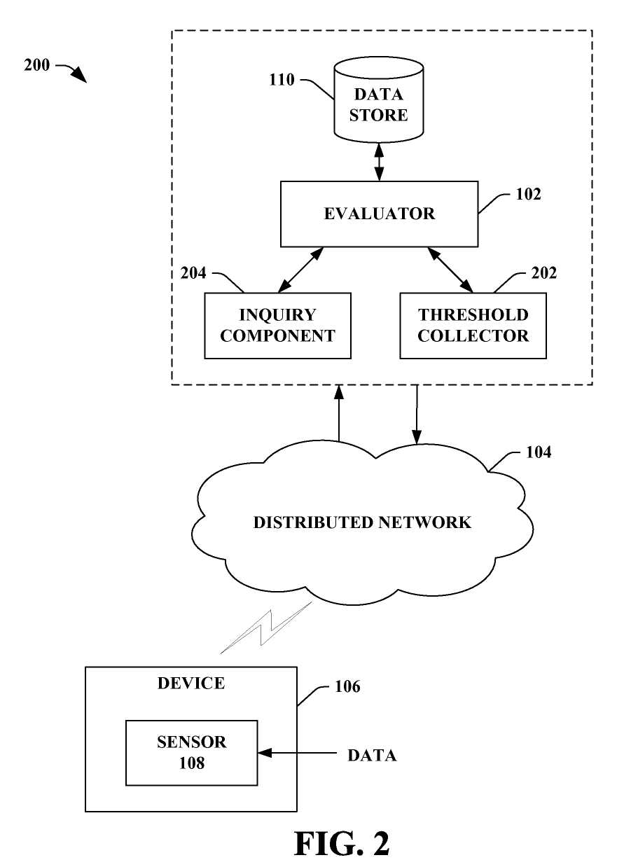

FIG. 2 illustrates a system 200 that facilitates aggregating health data via a distributed network for informative health updates. The system 200 can include the evaluator 102 that can receive data via the distributed network 104 from the device 106 and/or the sensor 108. Based upon aggregated data from the device 106 and/or the sensor 108, the evaluator can generate health informative updates to communicate to at least one user associated with the device 106. For example, the health informative update can be communicated to the device 106 utilizing a text message, an incoming call, an email, a page, a short service message (SSM), a website, a hyperlink, a portion of text, a portion of audio, a portion of a graphic, a portion of a video, etc.

For instance, the device 106 can be, but is not limited to being, a cellular device, a mobile device, a smartphone, a laptop, a desktop machine, a personal computer, a portable digital assistant (PDA), a media player, a media device, a portable media device, a gaming console, a portable gaming device, a messenger device, a web browsing device, a camera, a video camera, an email device, etc. In general, the device 106 can be any suitable electronic device capable of communicating a portion of data to a distributed network. For example, a laptop can tether with a cellular device in order to communicate data with a distributed network.

Moreover, the sensor 108 can detect and/or collect any data that can be indicative (e.g., solely or evaluated in combination with other data) of a medical condition. For example, the sensor 108 can collect internal user health data such as emotional data and/or physiological data. For instance, emotional data can be descriptive of user's condition/state, such as, but not limited to, happy, sad, cheerful, depressed, giddy, mad, angry, excited, nervous, headache, physical pain, mental anguish, tired, refreshed, sore, achy, alert, weak, strong, irritable, shaky, exercise data (e.g., duration of workout, type of workout, etc.), etc. Moreover, the physiological data can be, for instance, medical related measurements, statistics, levels, demographic data (e.g., height, weight, body part measurements, etc.), a heart rate, a blood pressure reading, vital signs, a body temperature, a skin temperature, respiration rate (e.g., rate of breathing), body fat percentage, body inductance, reflexes, eyesight measurements, strength rating, blood evaluation (e.g., oxygen levels, substance level within blood, pH values, acid level, alkaline level, sodium level, chloride ion level, blood glucose level, alcohol levels, etc.), sodium level, glucose levels, toxic levels within a body, cardiovascular system monitoring, pulmonary system monitoring, cellular respiration tracking, hormonal level, anti-diuretic hormone (ADH) reading, carbon dioxide levels, tidal volume, lung capacity, electrocardiogram data, spirometer data, peak flow meter data, sinus tachycardia data, bradycardia data, sinus arrhythmia data, health readings during exercise, and/or any other data related to a medical measurement or medical condition.

The sensor 108 can further detect external user health data. External user health data can be any suitable parameters that can provide an insight to detecting a medical condition or potential health hazard/concern, wherein such parameters are external from the user. For instance, external health data can be air quality, contaminants in air, oxygen levels within air, air toxin levels, temperature, humidity, precipitation, carbon dioxide levels, second-hand smoke amounts, radiation levels, radio wave exposure, mercury levels from digested food, acceleration, pressure, physical contact, geographic position, movement, sun exposure (ultraviolet rays), animal interaction (e.g., bug bites, snake bites, touching animals, etc.), allergy levels (e.g., pollen count, animal fur, etc.), smog, audio (e.g., accident indicative noises, screams, moans, etc.), amount of light or darkness, scents, tiredness, amount of smoke, amount of dust particles, etc.

The system 200 can further include a threshold collector 202. In general, the threshold collector 202 can identify thresholds or limits in connection with a level or reading for collected data. As mentioned above, the health informative update generated by the evaluator 102 can pertain to a population (e.g., a large epidemic is detected based upon data analysis) or a specific user (e.g., a health condition related to a particular user is identified based upon data analysis). Thus, the threshold collector 202 can identify thresholds or limits for health informative updates (e.g., population updates, personal updates, etc.). The threshold collector can automatically determine a threshold level or limit based upon evaluation of medical conditions and/or symptoms. For example, a number of physiological related levels can be determined based upon medical information (e.g., oxygen levels, tolerable toxin levels, etc.). Moreover, threshold levels or limits can be user-defined (e.g., user knows two hours of sunlight is a limit prior to getting sun burned) or identified based upon evaluation of historic data related to such user (e.g., system collects data over time and determines that a specific user has a sun exposure limit of four hours prior to getting burned). In addition, such threshold or limits can be adjusted in light of evaluation of newly discovered medical data, a medical finding, a medical related research result, collected data from the sensor 108, etc.

The system 200 can further include an inquiry component 204 that can provide condition-specific data collection from a user identified as having a medical condition. Upon providing a personal health informative update, the inquiry component 204 can question or interview the user in order to collect condition specific data under such detected conditions or levels. For example, a medical condition such as heat stroke can include particular levels of parameters (e.g., temperature, age, duration of time within temperature, water intake, etc.) that can be indicative of such condition. Upon communicating a personal health informative update to a user susceptible to heat stroke (as detected by the device and/or sensor), data can be further collected in relation to the condition identified. By identifying a condition based upon the sensor-gathered material, more medical data can be actively collected for heat stroke condition. Thus, the inquiry component 204 can provide a questionnaire, a series of questions, an open forum, an interactive chat, any suitable data communication in which a user can receive questions or inquiries and respond, etc. in order to extract user health status/feelings in combination with detected levels for a particular condition (here heat stroke).

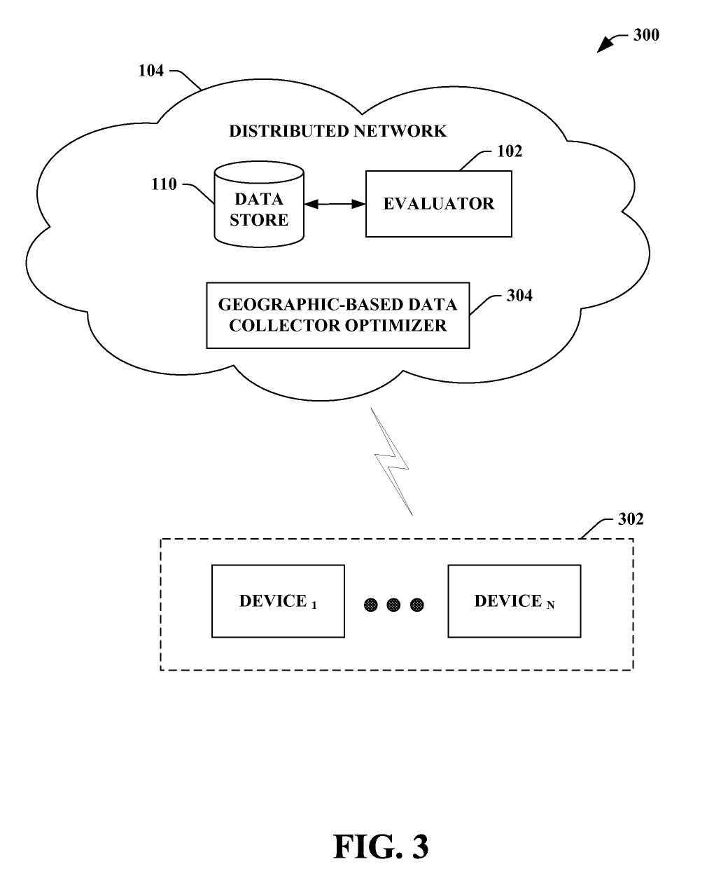

FIG. 3 illustrates a system 300 that facilitates managing devices associated with a distributed network in order to optimize health data collection. The system 300 can include the evaluator 102 that can create a health informative update based upon analysis of real time data collected from at least one device 302 associated with the distributed network 104. It is to be appreciated that any suitable number of devices can collect or gather data such as device ₁ to device _{N}, where N is a positive integer. By leveraging the distributed network 104, collecting data for determining health informative updates can be continuous and provide a wide geographic coverage.

The system 30 can include a geographic-based data collector optimizer 304. The geographic-based data collector optimizer 304 (also referred to as the “GDCO 304”) can coordinate devices and/or sensors within a proximity of one another in order to optimize data collection for reduced redundancy. For example, rather than each device collecting parameters, the GDCO 304 can provide coordination in which parameters can be distributed to devices within close geographic proximity. In other words, the parameters can be detected or gathered by a close proximity of devices and shared in order to optimize data collection and data evaluation. It is to be appreciated that the distribution of data collection responsibility can be based on any suitable criteria such as, but not limited to, sensor availability, sensor capability, device availability, device capability, bandwidth, connection, signal strength, condition-based (e.g., device A collects parameters for a first condition, device B collects etc.), parameter-based (e.g., a first device collects parameters A, B, and C, a second device collects parameters D, E, and F, etc.), etc.

The evaluator 102 can identify relationships, correlations, and/or potential conclusions/outcomes from the collected data. In general, the evaluator 102 can predict outcomes, provide medical related trends, determine diagnosis, generate advice, translate situations, and/or provide reliable insight from a medical viewpoint. It is to be appreciated that the evaluator 102 can examine data (and/or associated metadata) from at least one device 302 and/or sensor (not shown) in order to glean information to assist in creating a health informative update. The evaluator 102 can further employ any suitable inference technique (discussed in more detail below) such as, but not limited to, Bayesian theory, neural networks, etc.

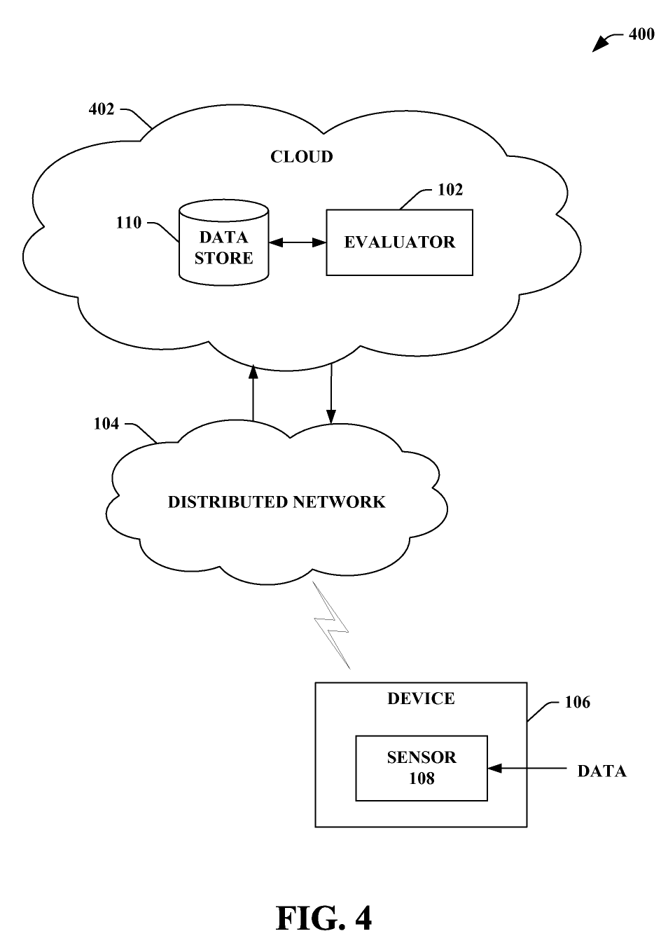

FIG. 4 illustrates a system 400 that facilitates enabling seamless health data collection utilizing a cloud. The system 400 can utilize a cloud 402 that can incorporate at least one of the evaluator 102, the distributed network 104, the device 106, the sensor 108, the data store 110, and/or any suitable combination thereof. It is to be appreciated that the cloud 402 can include any suitable component, device, hardware, and/or software associated with the subject innovation. The cloud 402 can refer to any collection of resources (e.g., hardware, software, combination thereof, etc.) that are maintained by a party (e.g., off-site, on-site, third party, etc.) and accessible by an identified user over a network (e.g., Internet, wireless, LAN, cellular, Wi-Fi, WAN, etc.). The cloud 402 is intended to include any service, network service, cloud service, collection of resources, etc. and can be accessed by an identified user via a network. For instance, two or more users can access, join, and/or interact with the cloud 402 and, in turn, at least one of the evaluator 102, the data store 110, the inquiry component (not shown), the threshold collector (not shown), the geographic-based data collector optimizer (not shown), and/or any suitable combination thereof. In addition, the cloud 402 can provide any suitable number of service(s) to any suitable number of user(s) and/or client(s). In particular, the cloud 402 can include resources and/or services that enable a health informative update to be provided in which the health informative update relates to a population (e.g., population update) or a particular user (e.g., personal update).

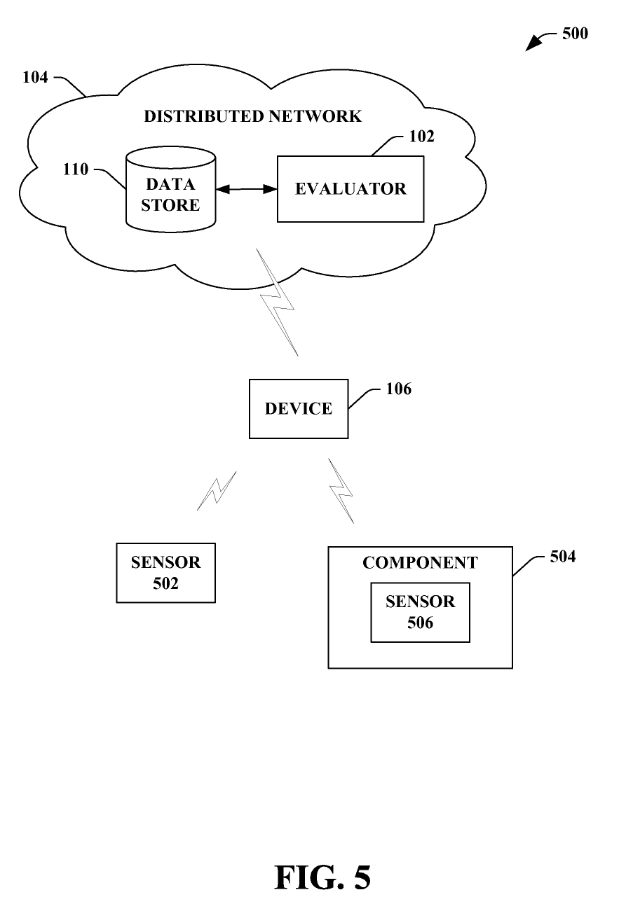

FIG. 5 illustrates a system 500 that facilitates utilizing component sensors to collect information in accordance with the subject innovation. The system 500 can include the device 106 which can communicate collected data to via distributed network 104, wherein such collected data can be utilized to provide a user with a health informative update. Real-time and continuous data collection can be provided by the device 106. As discussed, the device 106 can include a sensor (not shown) in order to collect data (e.g., internal health data, external health data, etc.). Moreover, the device 106 can communicate with an independent sensor 502, wherein data collected can be communicated (e.g., wirelessly, hard-link, wired connection, etc.) to the device 106 and communicated via the distributed network 104. In still another example, the device 106 can be a proxy to a component 504 and incorporated sensor 506. For example, the component 504 can be an automobile and the sensors can be incorporated therewith (e.g., speed, geographic location, temperature, oxygen sensor, etc.). It is then to be appreciated that the component 504 can be any suitable machine, electronic device, computer, hardware, etc. that can include a sensor to detect or monitor a parameter that can be indicative of a medical condition.

Generally, the data can be detected by various applications, devices, components, and the like. In one example, health data can be collected from the sensor 502 that specifically gathers or dynamically collects health data (e.g., a heart monitor, a sphygmomanometer, a respirator, a thermometer, etc.). In another example, data can be collected by an item or device with data collection capabilities or potential (e.g., a cellular device, an application, a portion of software, a mobile device, a gaming console, a portable gaming device, a media player, a communication device, a pager, a messaging device, a watch, a ring, an article of clothing, a portable digital assistant (PDA), a smartphone, an item of jewelry, a global positioning system (GPS) device, an accelerometer, a motion detector, a sensor, etc.), etc. For example, a user can communicate data with an electronic device such as a smartphone, computer, laptop, and the like, wherein such data can be submitted via the distributed network 104. In other words, data can be communicated and received by any electronic device with access to the distributed network 104.

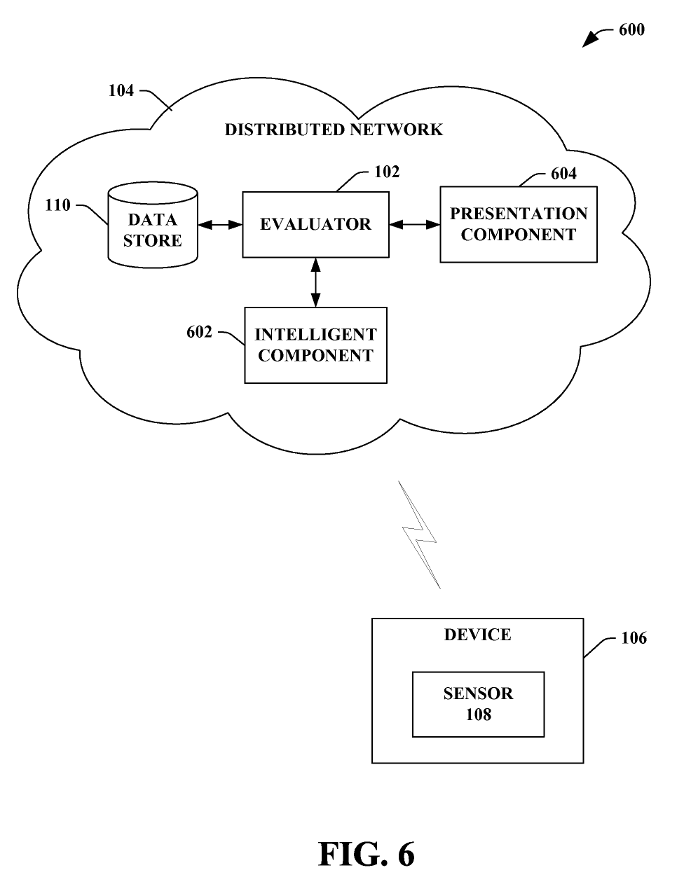

FIG. 6 illustrates a system 600 that facilitates collecting data via a device associated with a distributed network. The system 600 can include the evaluator 102, the distributed network 104, the device 106, the sensor 108, the data store 110, which can be substantially similar to respective evaluators, networks, devices, sensors, and data stores described in previous figures. The system 600 further includes an intelligent component 602. The intelligent component 602 can be utilized by the evaluator 102 to facilitate generating a health informative update for at least one of a population or a specific user. In addition, the intelligent component 602 can facilitate generating at least one of a trend, a predicted outcome, a relationship, a correlation, and/or any other medical advice ascertained by evaluating collected data. For example, the intelligent component 602 can infer internal user health data, external user health data, sensor collection, data collection, type of data to collect, data collection distribution, semantic relationships, semantic storage of collected data, sorting of collected data, organization of data, VOI of data in accordance to a particular user, VOI of data collection for parameters, VOI for medical conditions, VOI for health informative updates, device settings, evaluation of data, predicted outcomes, relationships between medical conditions and levels of parameters, parameter readings or measurements, user-specific medical conditions, user-specific levels of parameters related to a medical condition, medical advice, medical insight based upon gathered data, a trend ascertained from gathered data, cloud settings, etc.

The intelligent component 602 can employ value of information (VOI) computation in order to identify a most valuable trend, relationship, correlation, outcome, and/or medical insight for collected data and/or a health informative update. For instance, by utilizing VOI computation, the most ideal and/or appropriate health informative update for a user can be gleaned from data collected. Moreover, it is to be understood that the intelligent component 602 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

The evaluator 102 can further utilize a presentation component 604 that provides various types of user interfaces to facilitate interaction between a user and any component coupled to the evaluator 102. As depicted, the presentation component 604 is a separate entity that can be utilized with the evaluator 102. However, it is to be appreciated that the presentation component 604 and/or similar view components can be incorporated into the evaluator 102 and/or a stand-alone unit. The presentation component 604 can provide one or more graphical user interfaces (GUIs), command line interfaces, and the like. For example, a GUI can be rendered that provides a user with a region or means to load, import, read, etc., data, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed. For example, the user can interact with one or more of the components coupled and/or incorporated into the evaluator 102.

The user can also interact with the regions to select and provide information via various devices such as a mouse, a roller ball, a touchpad, a keypad, a keyboard, a touch screen, a pen and/or voice activation, a body motion detection, for example. Typically, a mechanism such as a push button or the enter key on the keyboard can be employed subsequent entering the information in order to initiate the search. However, it is to be appreciated that the claimed subject matter is not so limited. For example, merely highlighting a check box can initiate information conveyance. In another example, a command line interface can be employed. For example, the command line interface can prompt (e.g., via a text message on a display and an audio tone) the user for information via providing a text message. The user can then provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, EGA, VGA, SVGA, etc.) with limited graphic support, and/or low bandwidth communication channels.

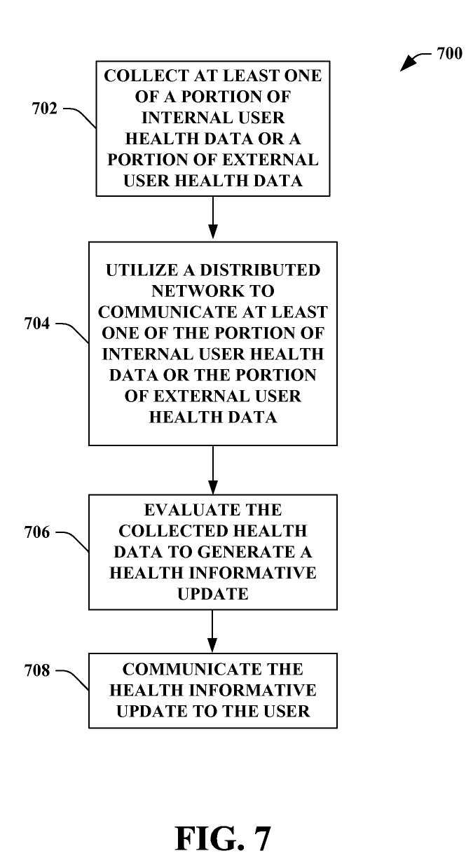

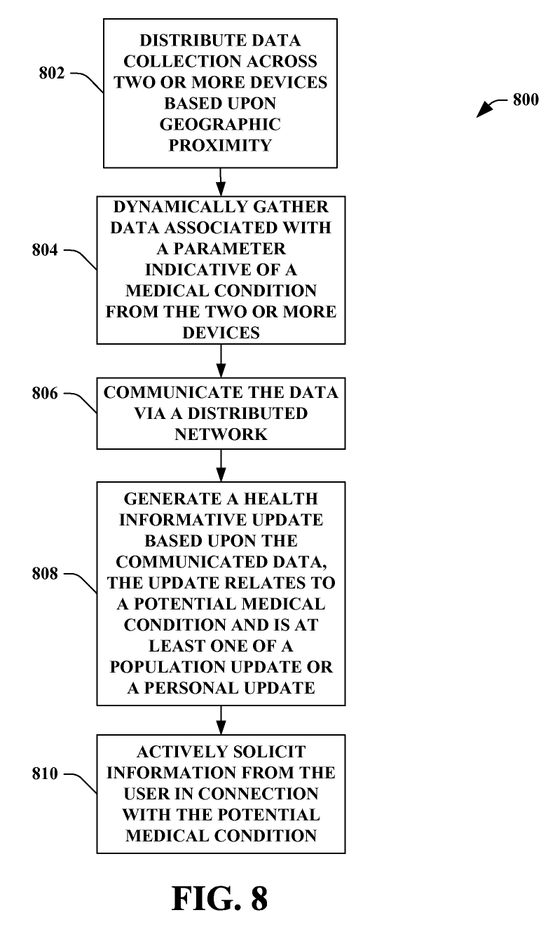

FIGS. 7-8 illustrate methodologies and/or flow diagrams in accordance with the claimed subject matter. For simplicity of explanation, the methodologies are depicted and described as a series of acts. It is to be understood and appreciated that the subject innovation is not limited by the acts illustrated and/or by the order of acts. For example acts can occur in various orders and/or concurrently, and with other acts not presented and described herein. Furthermore, not all illustrated acts may be required to implement the methodologies in accordance with the claimed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 7 illustrates a method 700 for leveraging a distributed network in order to collect data utilized to provide health information updates. At reference numeral 702, at least one of a portion of internal user health data or a portion of external user health data can be collected. External user health data can be any suitable parameters that can provide an insight to detecting a medical condition or potential health hazard/concern, wherein such parameters are external from the user. Furthermore, internal user health data can be internal data from a user which can be indicative of a medical condition—such as emotional data and/or physiological data.

At reference numeral 704, a distributed network can be utilized to communicate at least one of the portion of internal user health data or the portion of external user health data. For instance, a cellular device on a distributed network can collect data via a sensor in which such collected data can be communicated within the distributed network. At reference numeral 706, the collected health data (e.g., the internal user health data, the external user health data, or any suitable combination thereof) can be evaluated to generate a health informative update. In general, various relationships and/or correlations can be examined in order to identify a potential health condition or medical threat/concern in which detected parameters or levels are indicative thereof. At reference numeral 708, the health informative update can be communicated to the user. For example, the health informative update can be communicated to the device utilizing a text message, an incoming call, an email, a page, a short service message (SSM), a website, a hyperlink, a portion of text, a portion of audio, a portion of a graphic, a portion of a video, etc.

FIG. 8 illustrates a method 800 for facilitates aggregating health data via a distributed network for informative health updates. At reference numeral 802, data collection can be distributed across two or more devices based at least in part upon geographic proximity. In general, data collection responsibilities can be distributed amongst two or more devices. For example, the data collection can be collected and shared in order to optimize resources related to devices, sensors, etc.

At reference numeral 804, data associated with a parameter indicative of a medical condition can be dynamically gathered from the two or more devices. For instance, a device can include a sensor for data collection. In another example, a device can communicate with a sensor for data collection. In still another example, a device can be a proxy to a component and related sensors. At reference numeral 806, the data can be communicated via a distributed network.

At reference numeral 808, a health informative update can be generated based upon evaluation of the communicated data, the health informative update relates to a potential medical condition and is at least one of a population update or a personal update. In one example, the health informative update can be a personal update that provides information pertaining to an individual-based medical condition or medical concern. In another example, the health informative update can be a population update, wherein a medical condition or medical threat/concern that affects an identified population is determined.

At reference numeral 810, the user can be actively solicited for information in connection with the potential medical condition identified. A user that receives a health informative update can be further questioned or interviewed in order to collect condition specific data under such detected conditions or levels. Thus, a questionnaire, a series of questions, an open forum, etc. can be utilized in order to actively solicit or extract user health status/feelings in combination with detected levels for a particular condition.

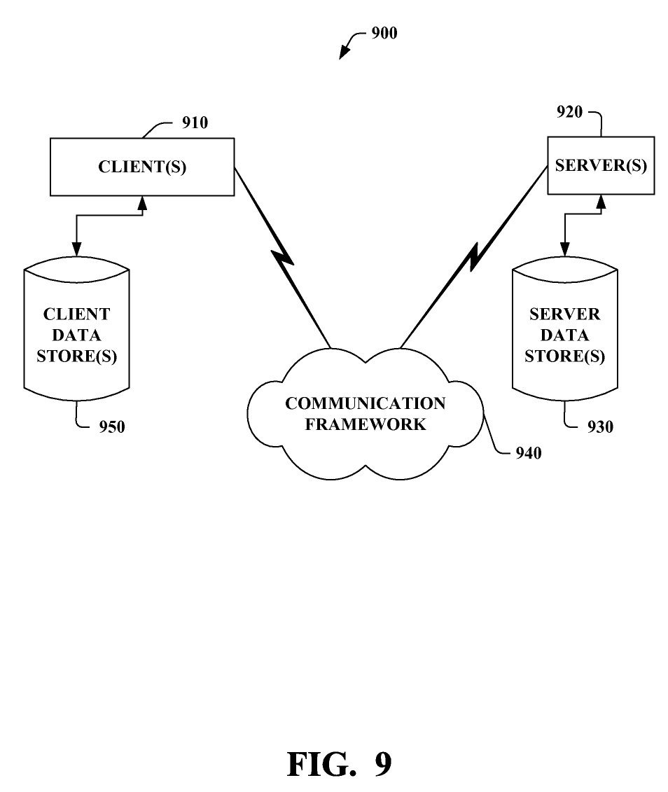

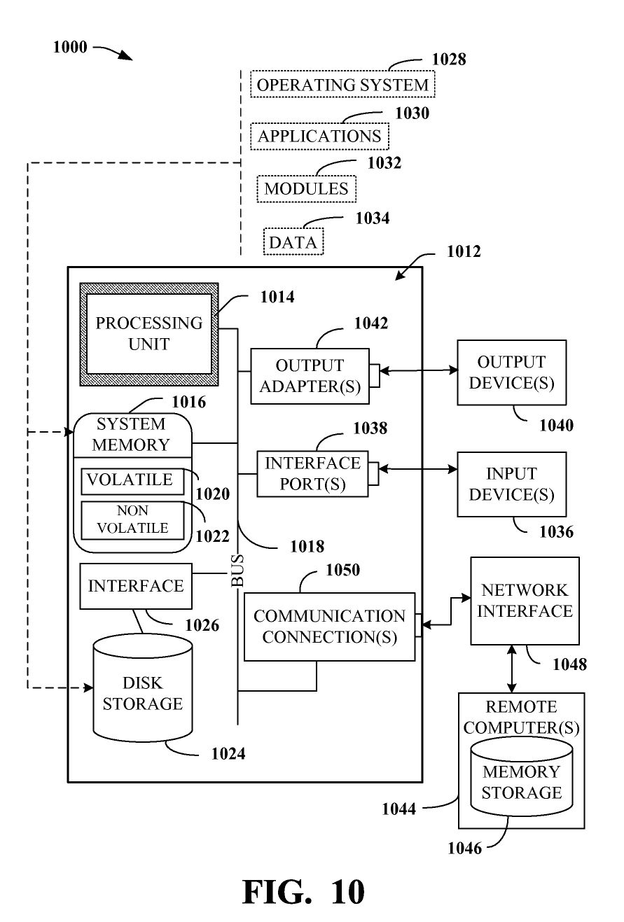

In order to provide additional context for implementing various aspects of the claimed subject matter, FIGS. 9-10 and the following discussion is intended to provide a brief, general description of a suitable computing environment in which the various aspects of the subject innovation may be implemented. For example, an evaluator that analyzes data collected via a distributed network in order to provide a health informative update, as described in the previous figures, can be implemented in such suitable computing environment. While the claimed subject matter has been described above in the general context of computer-executable instructions of a computer program that runs on a local computer and/or remote computer, those skilled in the art will recognize that the subject innovation also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the claimed subject matter may also be practiced in distributed computing environments where certain tasks are performed by remote processing devices that are linked through a communications network. However, some, if not all, aspects of the subject innovation may be practiced on stand-alone computers. In a distributed computing environment, program modules may be located in local and/or remote memory storage devices.

FIG. 9 is a schematic block diagram of a sample-computing environment 900 with which the claimed subject matter can interact. The system 900 includes one or more client(s) 910. The client(s) 910 can be hardware and/or software (e.g., threads, processes, computing devices). The system 900 also includes one or more server(s) 920. The server(s) 920 can be hardware and/or software (e.g., threads, processes, computing devices). The servers 920 can house threads to perform transformations by employing the subject innovation, for example.

One possible communication between a client 910 and a server 920 can be in the form of a data packet adapted to be transmitted between two or more computer processes. The system 900 includes a communication framework 940 that can be employed to facilitate communications between the client(s) 910 and the server(s) 920. The client(s) 910 are operably connected to one or more client data store(s) 950 that can be employed to store information local to the client(s) 910. Similarly, the server(s) 920 are operably connected to one or more server data store(s) 930 that can be employed to store information local to the servers 920.

With reference to FIG. 10, an exemplary environment 1000 for implementing various aspects of the claimed subject matter includes a computer 1012. The computer 1012 includes a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable programmable ROM (EEPROM), or flash memory. Volatile memory 1020 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1012 also includes removable/non-removable, volatile/non-volatile computer storage media. FIG. 10 illustrates, for example a disk storage 1024. Disk storage 1024 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in the suitable operating environment 1000. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that the claimed subject matter can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012, and to output information from computer 1012 to an output device 1040. Output adapter 1042 is provided to illustrate that there are some output devices 1040 like monitors, speakers, and printers, among other output devices 1040, which require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

There are multiple ways of implementing the present innovation, e.g., an appropriate API, tool kit, driver code, operating system, control, standalone or downloadable software object, etc. which enables applications and services to use the advertising techniques of the invention. The claimed subject matter contemplates the use from the standpoint of an API (or other software object), as well as from a software or hardware object that operates according to the advertising techniques in accordance with the invention. Thus, various implementations of the innovation described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A system that facilitates aggregating data with a distributed network for health-related diagnosis, comprising:
a device that includes a sensor that dynamically collects a portion of data, the portion of data is wirelessly communicated from the device to a distributed network;
an evaluator that generates a health informative update based at least in part upon an analysis of the dynamically collected portion of data received via the distributed network, the evaluator analyzes a medical condition with a condition-indicative level of the portion of data collected via the sensor; and
the health informative update is at least one of a personal update providing information pertaining to an individual-based medical condition or a geographic-based population update providing information related to a medical condition that affects a pre-defined number of individuals within the geographic-based population.

2. The system of claim 1, the collected data is a portion of internal user health data related to emotional data or physiological data.

3. The system of claim 2, the portion of physiological data is at least one of a medical related measurement, a medical statistic, or a level related to a wellness.

4. The system of claim 2, the portion of emotional data descriptive of at least one of a user's condition, a user's state, or a user's feelings.

5. The system of claim 1, the collected data is a portion of external user health data, the portion of external user health data is at least one of an air quality, a measurement of contaminants in air, an oxygen level, an oxygen level within air, an air toxin level, a temperature, a humidity, a precipitation, a carbon dioxide level, a second-hand smoke amount, a radiation level, a radio wave exposure, a mercury level from digested food, an acceleration, a pressure, a physical contact, a geographic position, a movement, a sun exposure, an animal interaction, an allergy level, a level of smog, a portion of audio, an amount of light or darkness, a scent, an amount of smoke, or an amount of dust particles.

6. The system of claim 1, the device is at least one of a cellular device, a mobile device, a smartphone, a laptop, a desktop machine, a personal computer, a portable digital assistant (PDA), a media player, a media device, a portable media device, a gaming console, a portable gaming device, a messenger device, a web browsing device, a camera, a video camera, an email device, or an electronic device capable of communicating data via the distributed network.

7. The system of claim 1, further comprising an inquiry component that actively solicits information from a user that receives the informative health update, the solicitation of information is targeted to the individual-based medical condition.

8. The system of claim 7, the inquiry component actively extracts information from the user utilizing at least one of a questionnaire, an open forum, or an interactive chat.

9. The system of claim 1, further comprising a threshold collector that identifies a level with at least one detected parameter in which such level is indicative of a medical condition, the level is dynamically adjusted based at least in part upon one of a user definition, a portion of historic data related to a user, a medical finding, or a medical related research result.

10. The system of claim 1, further comprising a geographic-based data collector optimizer that distributes data collection across two or more devices within the distributed network.

11. The system of claim 10, the geographic-based data collector optimizer distributes data collection responsibilities across two or more devices based upon at least one of a geographic proximity, a sensor availability, a sensor capability, a device availability, a device capability, an amount of available bandwidth, a connection, a signal strength, a condition-based criteria, or a parameter-based criteria.

12. The system of claim 1, the geographic-based population update relates to a population, the organization of the population is family member based, relationship based, age based, gender based, blood type based, or user-defined network.

13. The system of claim 1, further comprising at least one of the following:
the device incorporates the sensor for real-time data collection;
the device communicates with an independent sensor for real-time data collection; or
the device is a proxy to a component with an incorporated sensor.

14. The system of claim 1, the evaluator analyzes the aggregated data in order to generate at least one of a predicted outcome, a medical related trend, a determined diagnosis, a portion of medical advice, an interpretation of a user condition, or a reliable insight from a medical viewpoint, wherein such generated data is incorporated into the informative health update.

15. The system of claim 1, further comprising a cloud that incorporates at least one of the evaluator, the sensor, or the device.

16. The system of claim 15, the cloud is a collection of resources maintained by a party and accessible by an identified user over a network.

17. A computer-implemented method that facilitates leveraging a distributed network in order to provide medical information directly to a user, comprising:
collecting at least one of a portion of internal user health data or a portion of external user health data;
utilizing a distributed network to communicate at least one of the portion of internal user health data or the portion of external user health data;
evaluating the collected health data to generate a health informative update; and
communicating the health informative update to the user.

18. The method of claim 17, further comprising:
distributing data collection across two or more devices within the distributed network;
dynamically collecting data associated with a parameter that is indicative of a potential medical condition; and
communicating the informative health update to the user via the distributed network, the informative health update relates to a potential medical condition and is at least one of a population update or a personal update.

19. The method of claim 17, further comprising actively soliciting information from the user in connection with the potential medical condition.

20. A computer-implemented system that facilitates aggregating data with a distributed network for health-related diagnosis, comprising:
means for collecting data in real-time, the data is at least one of a portion of internal user health data or a portion of external user health data
means for distributing data collection between two or more devices based upon a geographic proximity;
means for communicating the data to a device associated with a distributed network;
means for receiving the data from the distributed network;
means for analyzing the data in connection with a characteristic of a medical condition, and identifying a potential medical condition the data correlates to a pre-defined amount of the characteristic;
means for generating a health informative update based at least in part upon an analysis of the data, the health informative update is at least one of a personal update providing information pertaining to an individual-based medical condition or a population update providing information related to a potential medical condition that affects a pre-defined group of individuals;
means for directly communicating the health informative update to the user via the distributed network; and
means for actively soliciting information from a user, the information is collected for the individual-based medical condition identified by the analysis of the data.
